(19) United States
(12) Patent Application Publication
(10) Pub. No.: US 2004/0206691 A1
(43) Pub. Date: Oct. 21, 2004

(54) Pleated support tubes for polymer filters

(76) Inventors: Brandon Paul Charin, Longmeadow, MA (US); John Charles Hoagland, Longmeadow, MA (US)

Correspondence Address: Brenc Law, 8925 Littleton Street, Fairfax, VA, 22032, US

(21) Appl. No.: 10/419,203

(22) Filed: Apr. 21, 2003

(51) Int. Cl. B01D 29/07

(52) U.S. Cl. 210/493.1; 210/497.01; 210/338

(57) ABSTRACT

The present invention is in the field of filtration of polymers and other compounds, and more specifically the present invention is in the field of high pressure polymer filtration. The present invention relates to pleated support tubes for filters that can be used, among other applications, for the filtration of polymer compounds used in various plastic applications. The present invention also relates to the use of sealing rings for use with the pleated tubes of the present invention. The present invention further relates to methods for using the pleated tubes or pleated tubes and sealing rings in the process of filtering compounds.

### FIELD OF THE INVENTION

The present invention is in the field of filtration of polymers and other compounds, and more specifically the present invention is in the field of high pressure polymer filtration.

### BACKGROUND

Polymer compounds are used in a multitude of applications, including, for example, plastic products and related materials. These polymer compounds can be produced through processes that involve the production of polymers in liquid states or melted polymers. The liquid polymeric compound can then be treated in a number of ways to produce a flowable compound with the desired properties that can be worked in various ways produce the final plastic product.

For polymeric compounds of many types it is often desirable to filter the compound when it is in its flowable state. One method of filtering polymeric compounds involves forcing the compounds through a filter at high pressure. The filter used for this technique can be made out of any material that can withstand the temperatures and pressures imposed by the process.

One conventional filter apparatus, known as a candle filter, uses a pleated mesh pack filter that is slidably positioned around a cylindrical hollow core tube. An example of this can be found in U.S. Pat. No. 5,279,733, which is herein incorporated by reference in its entirety. Although such a filter mesh pack/hollow core tube assembly can beneficially be used and then disassembled for mesh pack cleaning or replacement, the pleated mesh pack typically is made thicker than would otherwise be required in order to prevent crushing of the pleats by the higher pressures required by the filtering process after the mesh pack becomes partially clogged with filtered debris. Further, the cylindrical hollow core tube typically needs to have a narrow inner diameter in order to provide the necessary structural support for the filter apparatus, which increases the amount of pressure required to pass material through the filter. All of these characteristics lead to a shortened filter life.

What are needed in the art are filter apparatuses that are capable of better supporting mesh packs so that thinner mesh packs can be used for longer periods under high filtering pressures.

### SUMMARY OF THE INVENTION

The present invention is in the field of filtration of polymers and other compounds, and more specifically the present invention is in the field of high pressure polymer filtration. The present invention relates to pleated support tubes for filters that can be used, among other applications, for the filtration of polymer compounds used in various plastic applications, including polymer extrusion applications. The present invention also relates to the use of sealing rings for use with the pleated tubes of the present invention. The present invention further relates to methods for using the pleated tubes or pleated tubes and sealing rings in the process of filtering compounds.

The present invention includes a filter candle hollow core tube, comprising: an outer surface and an inner surface and having a longitudinal axis, wherein said outer surface is formed in pleats aligned in parallel with said longitudinal axis, and wherein said hollow core tube defines a plurality of openings between said outer surface and said inner surface and defines an axial opening at one end.

The present invention includes a filter candle apparatus comprising: an elongated screen pack defining an axial opening therethrough; a hollow core tube slidably, removably disposed within said axial opening of said screen pack, wherein said hollow core tube comprises an outer surface and an inner surface and has a longitudinal axis, wherein said outer surface is formed in pleats aligned in parallel with said longitudinal axis, and wherein said hollow core tube defines a plurality of openings between said outer surface and said inner surface and defines an axial opening at one end; and, wherein material can be passed through said mesh pack, into said hollow core tube, and out of said axial opening defined by said hollow core tube.

The present invention includes a method for filtering a flowable material, comprising: forcing said material through a filter candle apparatus, wherein said apparatus comprises: an elongated screen pack defining an axial opening therethrough; and, a hollow core tube slidably, removably disposed within said axial opening of said screen pack, wherein said hollow core tube comprises an outer surface and an inner surface and has a longitudinal axis, wherein said outer surface is formed in pleats aligned in parallel with said longitudinal axis, and wherein said hollow core tube defines a plurality of openings between said outer surface and said inner surface and defines an axial opening at one end.

### BRIEF DESCRIPTION OF THE DRAWINGS

FIG. 1 represents a perspective view of a conventional filter candle apparatus.

FIG. 2 represents a cross-sectional schematic view of a conventional hollow core support tube and mesh pack.

FIG. 3a represents a cross-sectional schematic view of one embodiment of a hollow core support tube of the present invention and screen pack.

FIG. 3b represents a cross-sectional schematic view of one embodiment of a hollow core support tube of the present invention and screen pack.

FIG. 3c represents a cross-sectional schematic view of one embodiment of a hollow core support tube of the present invention and screen pack.

FIG. 3d represents a cross-sectional schematic view of one embodiment of a hollow core support tube of the present invention and screen pack.

FIG. 4 represents a cross-sectional view of one embodiment of a hollow support tube and screen pack of the present invention.

FIG. 5 represents a perspective view of one embodiment of a hollow core tube of the present invention.

FIG. 6 represents a plot of the change in pressure versus the estimated weight of filtered material for an exemplary experimental run of two conventional filter/hollow core tubes and one embodiment of the present invention.

### DETAILED DESCRIPTION

The present invention relates to pleated hollow core support tubes for filters that can be used, among other applications, for the filtration of polymer compounds used in various plastics applications. The present invention also relates to the use of sealing rings for use with the pleated hollow core tubes of the present invention. The present invention further relates to methods for using the pleated hollow core tubes or pleated hollow core tubes and sealing rings in the process of filtering compounds.

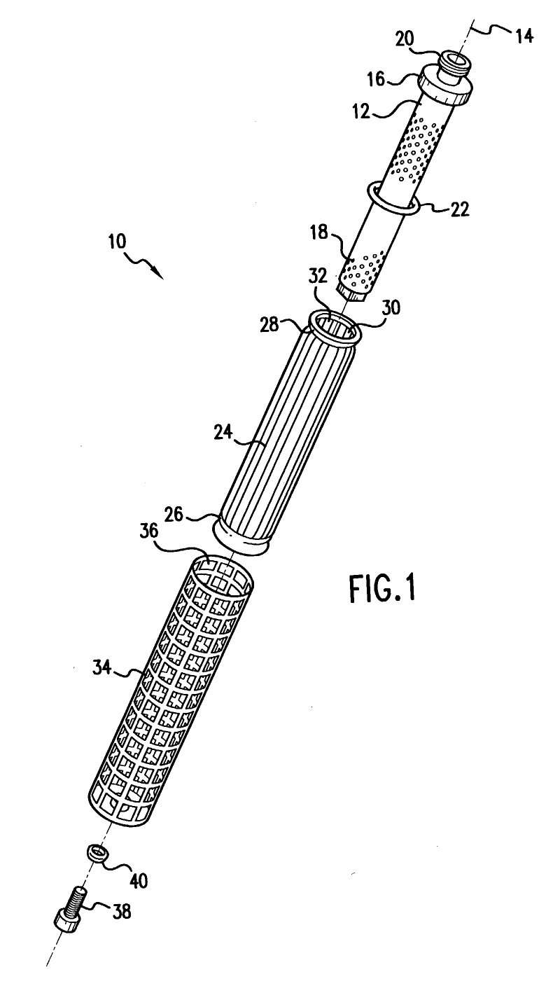

A conventional filter candle apparatus is shown in perspective in FIG. 1 generally at 10. This view shows a conventional cylindrical hollow core tube 12, an elongated pleated mesh pack 24, and a protective, optional, sheath 34 in a disassembled state along a shared longitudinal axis 14. In an assembled state, the hollow core tube 12 would be inserted into an axial opening 32 of the mesh pack 24 until an end fitting 28 on the mesh pack 24 is positioned in contact with an end member 16 disposed on the hollow core tube 12. The coupled mesh pack 24 and hollow core tube 12 assembly can then be inserted into the protective sheath 34, and a bolt 38 with a washer 40 can be used to secure the entire assembly.

Flowable material can be filtered using the apparatus shown in FIG. 1 by passing the material under pressure through openings 36 in the sheath 34, thereby placing the material in contact with the mesh pack 24. The material is forced through the mesh pack 24 and into contact with the hollow core tube 12. An end cap 26 on one end of the mesh pack 24 and a seal 22 that is located in a recess 30 defined by the end fitting 28 prevent the material from leaking around the mesh pack 24 to the hollow core tube 12.

The material is then forced into the hollow core of the hollow core tube 12 through a plurality of openings 18 defined in the hollow core tube. The material is finally forced out through an end of the hollow core tube 12 that has threads 20 for attaching the entire apparatus to a machine or additional fittings.

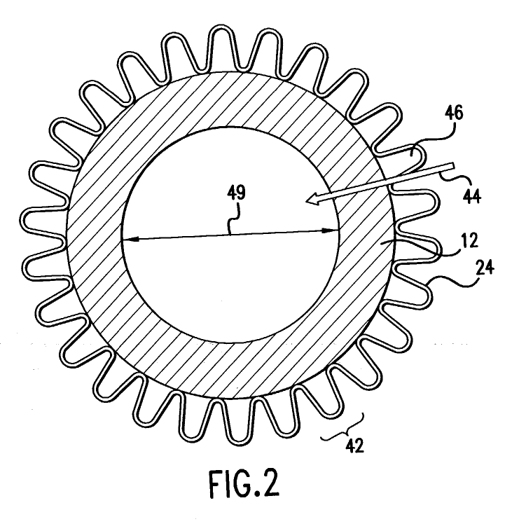

A schematic cross-sectional view of a the hollow core tube 12 and mesh pack 24 taken at about the center point of the assembled unit depicted in FIG. 1 is shown in FIG. 2. FIG. 2 shows the cylindrical hollow core tube 12 in position within the pleated mesh pack 24. For simplicity, the plurality of openings 18 are not shown in the hollow core tube 12. A single pleat is shown at 42. The flow of material from the outside of the mesh pack 24, through the mesh pack 24 and through the hollow core tube 12 is shown by the arrow at 44. The space between the mesh pack 24 and the hollow core tube 12 for which the mesh pack 24 is unsupported is shown at 46.

As shown in FIG. 2, the unsupported mesh pack space 46 forces the use of a mesh pack 24 having a larger than ideal thickness. Further, the inner diameter 49 of the hollow core tube 12 is relatively narrow. Because the conventional mesh pack 46 is disposed in contact with a hollow core tube 12 that has unsupported space 46 under the mesh pack 24, the mesh pack 24 must be formed with a thickness great enough to support itself. This additional thickness can be undesirable.

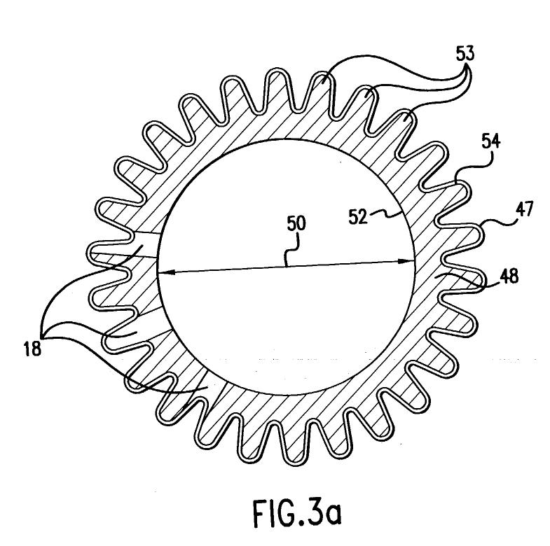

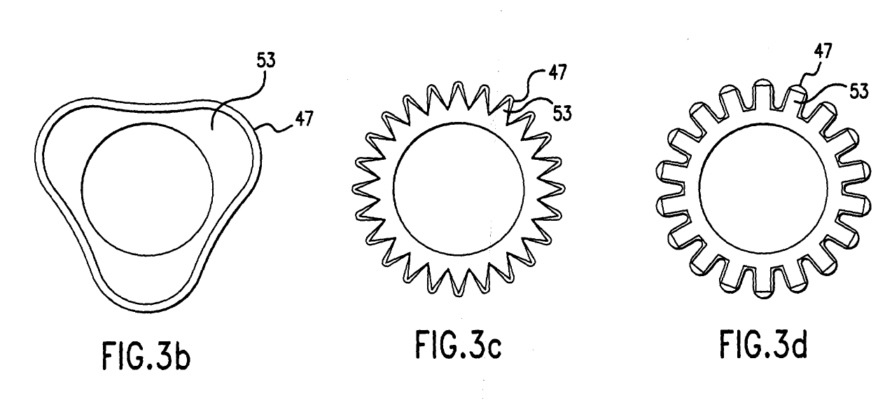

FIG. 3a shows the same cross sectional view shown in FIG. 2 but with one embodiment of a hollow core tube 48 of the present invention shown in place of a conventional hollow core tube 12. The plurality of openings 18 are defined in the hollow core tube 48. This embodiment of the hollow core tube 48 of the present invention comprises an inner surface 52 and an outer surface 54. The outer surface 54 is formed so as to have undulating pleats 53 aligned in parallel with the longitudinal axis 14 of the hollow core tube 48. As shown, this arrangement provides superior support for the screen pack 47 along its entire form. That is, the shape of the screen pack 47 generally conforms to the shape of the pleats 53. The screen pack 47 of this embodiment differs from the mesh pack 24 of other embodiments and the prior art because the screen pack 47 shown does not require any end fittings or end caps, but rather is formed from one or more layers of screen mesh material layered together and formed into the compatible pleated shape. The arrangement of pleated hollow core tube 48 and screen pack 47 shown in FIG. 3a provides additional support for the screen pack 47 relative to the conventional hollow core tube 12, which both prevents screen pack 47 damage due to high pressure, allows the use of thinner screen packs 47, and allows the use of a pleated hollow core tube 48 having a larger inner diameter 50 than conventional hollow core tubes 12 used for the same application. The combination of these features allows the filtering apparatuses of the present invention to be used over a greater range of pressure, which extends the useful life of the screen pack 47 relative to conventional applications.

The pleated hollow core tube 48 of the present invention can be made out of any suitable material as is well known in the art, including, but not limited to, carbon steel, stainless steel, titanium, and combinations thereof. In a preferred embodiment, the hollow core tube of the present invention comprises 4140 carbon steel. Those of ordinary skill in the art will recognize that an appropriate hollow core tube 48 material can readily be chosen depending on the intended application.

The hollow core tube 48 can be made in any shape that substantially conforms to the screen pack 47 in order to provide the desired support. For example, the pleats 53 shown in FIG. 3a can be altered to be blunted, more or less pointed in cross section, project further or less far from the longitudinal axis 14, or otherwise be adjusted generally to support any particular screen pack 47 shape. FIGS. 3b through 3d represent exemplary embodiments of alternative hollow core tubes 48. FIG. 3b shows a hollow core tube 48 having blunted pleats 53. FIG. 3c shows a hollow core tube 48 having pointed, gear-like pleats 53. FIG. 3d shows a hollow core tube 48 having three larger pleats 53 having a larger triangular shape. As can be seen from these figures, any pleated shape can be used that substantially conforms to the desired screen pack 47 shape or otherwise provides the desired support of the screen pack 47. As used herein, a “pleat” 53 on a hollow core tube 48 means any outward projection, as viewed in cross section, formed on the regular outer surface 54 of the hollow core tube 48. For a cylindrical hollow core tube 48, for example, any projection deviating from the circular cross-sectional shape can be a pleat 53. In a preferred embodiment the pleats 53 are undulating and regularly spaced, as shown in FIG. 3a. It is also possible for pleats to be irregularly spaced around the perimeter of the cross-sectional hollow core tube 48. One of ordinary skill in the art will recognize that the crafting of pleats 53 will depend on the available space and desired screen pack 47 shape. Because pleats 53 of the present invention will support the screen pack 47 better than an equivalent hollow core tube 12 lacking pleats 53, it is desirable but not necessary that pleats 53 of the present invention substantially conform to the shape of the screen pack 47 in order to provide maximum support. It is also possible, as shown in FIG. 3b, that pleats 53 can be formed that are not a perfectly complementary shape to the screen pack 47.

In various embodiments of the present invention, hollow core tubes 48 can have fewer than 30, 25, 20, 15, 10, 5, or fewer than 4 pleats. Alternatively, in a typical embodiment, hollow core tubes 48 can have at least 15, at least 20, at least 25, or at least 30 pleats. Pleats 53 may have a base width, as measured in cross section, of between 3 mm and 12 mm, between 5 mm and 10 mm, or between 6 mm and 8 mm. Pleats 53 preferably project outward from the hollow core tube 48, as measured in cross section, between 2 mm and 12 mm, between 4 mm and 10 mm, or between 6 mm and 8 mm. In a preferred embodiment, pleats 53 are formed so as to have shallow depressions or grooves that better allow flow of material to the plurality of openings 18. These grooves can be formed so as to run longitudinally along the length of the pleats 53, or in any other manner to facilitate flow to the plurality of openings 18 after material has passed through the screen pack 24. In one embodiment, pleats 53 have two to four grooves running longitudinally and spaced evenly along the projection of the pleats 53 away from the longitudinal axis 14. In a typical embodiment, the inner diameter 50 of the hollow core tube 48 may be from 2 cm to 20 cm or more, 4 cm to 15 cm, and 5 cm to 10 cm. The length of the pleated portion of the hollow core tubes 48 of the present invention as measured along the longitudinal axis 14 may be at least 20 cm, at least 40 cm, at least 50 cm, at least 60 cm, at least 70 cm, at least 80 cm, at least 90 cm, and at least 100 cm or more. One of ordinary skill in the art will recognize that the dimensions and specifications provide above and throughout this specification are exemplary, and any other dimensions and specifications are possible, readily determinable depending on the intended application, and within the spirit and scope of the present invention.

Hollow core tubes 48 of the present invention can be machined to provide fittings at either end as required by any particular application. In one embodiment, a first end of a hollow core tube 48 is fitted with a cap that blocks flow through that first end. The cap can be machined so as to accept a bolt 38. A second end of a hollow core tube 48 opposite the first end can be machined to accept any fitting that provides the needed sealing. Hollow core tubes 48 of the present invention can be machined to have threads 20 as described above.

The plurality of openings 18 in the hollow core tubes 48 of the present invention can be formed in any shape and size that is suitable for the particular application. The openings 18 can be formed through the pleats 53, between the pleats 53, or both through the pleats 53 and between the pleats 53 (see, for example, FIG. 3a). The openings 18 can be formed along a line of evenly spaced circles each centered along the longitudinal axis 14, can be formed along lines running parallel to the longitudinal axis 14, and can be staggered relative to each other. In various embodiments 10 to 100 rows, 20 to 80 rows, and 30 to 70 rows of openings 18 along lines of evenly spaced circles each centered along the longitudinal axis 14 are defined by the hollow core tube 48. In these embodiments, each row of openings 18 can contain 5 to 50, 10 to 40, and 20 to 30 openings 18. Openings can be of any suitable size and shape, for example cylindrical and from 3 to 10 mm in diameter.

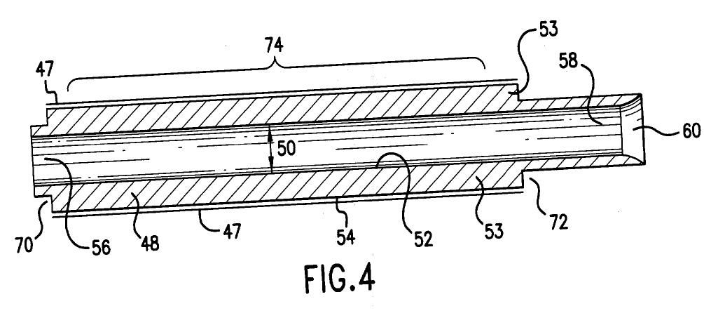

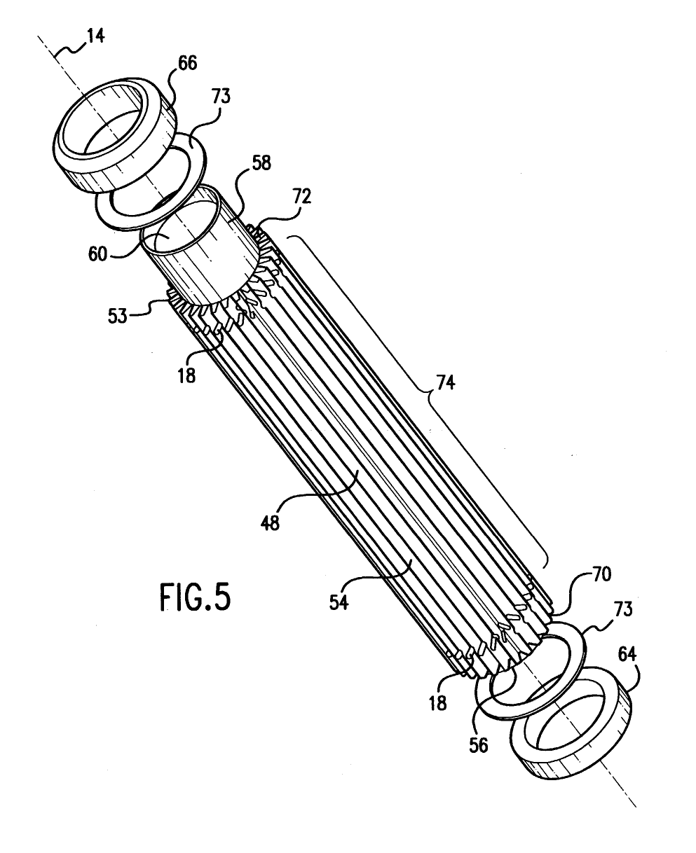

A cross section along the longitudinal axis 14 of one embodiment of the present invention is shown in FIG. 4. In this embodiment, the screen pack 47 used does not require any end fittings. This feature simplifies the design of the screen pack 47 and lowers the cost of manufacture. As shown in FIG. 4, this embodiment comprises a pleated hollow core tube 48 having an inner diameter 50, a first end 56, a second end 58 opposite the first end, and an axial opening 60 defined in the second end. In the view shown, the plurality of openings 18 passing from the outer surface 54 to the inner surface 52 are not shown. In this embodiment, pleats 53 project outward from the hollow core tube 48. A cone shaped device for directing flow toward the second end 58 can be inserted within the first end 56 of the hollow core tube 48, as is known in the art.

As shown in FIG. 4, the pleats 53 extend along the length of the hollow core tube 48 to a distance equivalent to the length of the screen pack 47. Sealing of the edges of the screen pack 47 can be accomplished by use of any suitable gasket having a high enough melting temperature to withstand the filtering process being used. For example, a Gore-Tex™ gasket can be used (PN/TF-0-0 DIN28091, W. L. Gore & Associates, Inc., Elkton, Md.) for a process employing temperatures of about 200° C. Any suitable gasket can be positioned over the ends of the hollow core tube 48 into positions 70 and 72, where one side of the gasket will be disposed in contact with the end of the pleats 53 and the screen pack 47. An end cap can be fitted onto the first end 56 of the hollow core tube 48, which can be threaded or otherwise provide for attachment of an end cap, and against the gasket located at position 70, thereby compressing the gasket into the end of the screen pack 47. Any suitable device can be fitted over the second end 58 and up against the gasket located at position 72 to similarly seal the opposite end of the screen pack 47 and pleats 53. In a preferred embodiment, a ring is fitted over second end 58 of the hollow core tube and fixed in position against the gasket located at position 72. The ring can be fixed in position by any suitable means, including, for example, through the use of a set screw.

The embodiment shown in FIG. 4 and as described above provides for suitable sealing of the screen pack 47 ends. To facilitate sealing, the plurality of openings 18 and/or any grooves can be formed within a subregion 74 of the pleats 53 that does not form the area immediately adjacent to gasket locations 70 or 72. In this manner, the screen pack 47 is placed in full contact with the hollow core tube along a small region at each end of the screen pack 47. When pressure is applied to the system, the ends of the screen pack 47 are forced down and held in position on the portion of the pleats 53 in which no holes or grooves have been formed, forming a tight seal. The gaskets prevent leakage around and under the ends of the screen pack 47. As will be clear to those in the art, the principle of sealing described above can be achieved by many means and many fittings, and will vary depending upon the particular application for which the filtering apparatuses of the present invention are used.

Again referring to FIG. 4, the second end 58 of the hollow core tube 48 can be designed to allow the use of the hollow core tube 48 in any suitable machine, and can be designed to be fitted with any additional desired components.

FIG. 5 represents a perspective view of one embodiment of a hollow core tube 48 of the present invention. In this view, for clarity, no screen pack 47 is shown, and only two rows of the plurality of openings 18, one on each end of the pleats 53, are shown. These two rows, one on each end of the pleats 53, are defined at the ends of a subregion 74. FIG. 5 shows a pleated hollow core tube 48 of the present invention with an outer surface 54, gaskets 73 and end cap 64 and sealing ring 66 in an exploded view along a common longitudinal axis 14. The pleated hollow core tube 48 has a first end 56 and a second end 58. An axial opening 60 in defined in the second end 58. The gaskets 73, when assembled, are disposed in contact with the end of the pleats 53 at positions 70 and 72.

Screen pack 47 of the present invention can be made out of any suitable material, as is known in the art. Screen pack 47 is preferably formed from fewer than 6 layers, 5 layers, or 4 layers of individual screen layers. The individual screen layers can have the same or different sized openings. In a preferred embodiment, each screen layer has a larger opening size than the adjacent underlying layer in order to provide support. In various embodiments of the present invention, the screen pack 47 of the present invention has a thickness of 0.1 to 10 mm, 0.25 to 5 mm, 0.5 to 2.5 mm, and 1.0 to 1.5 mm. In various embodiments of the present invention, the screen pack 47 of the present invention has a thickness of less than 10 min, 5 mm, 2.5 mm, and less than 1.5 mm.

The present invention also includes methods for filtering materials comprising forcing material through any of the screen pack 47/hollow core tube 48 assemblies of the present invention. In a preferred embodiment, the material is a polymeric compound. In these embodiments, material is forced through the screen pack 47, through the hollow core tube 48, and out through the axial opening 60 in the second end 58 of the hollow core tube 48.

The present invention also includes methods for sealing screen packs 47 of the present invention during use, comprising providing a pleated hollow core tube 48 lacking openings 18 or grooves over a small region at each end of the pleats 53, positioning a screen pack 47 in place over the hollow core tube 48, and sealing the ends of the screen pack 47 and pleats 53 with a gasket and end fittings, such as end caps and sealing rings.

The filtering apparatuses and methods of the present invention can be used to filter any suitable material. One of ordinary skill in the art will recognize that the various parameters given throughout this specification can be readily altered to produce hollow core tubes 48 and screen packs 47 that are useful for many applications and are within the scope and spirit of the present invention. It will be recognized that for any given application having a pleated mesh pack 24 and conventional hollow core tube 12, use of the present invention in that exact same application will allow the use of a screen pack 47 of equivalent outside surface area but having a smaller thickness as well as the use of a pleated hollow core tube 48 having a larger inner diameter 50 relative to the inner diameter 49 of a conventional cylindrical hollow core tube 12.

Any figure reference numbers given within the abstract or any claims are for illustrative purposes only and should not be construed to limit the claimed invention to any one particular embodiment shown in any figure.

### EXAMPLE 1

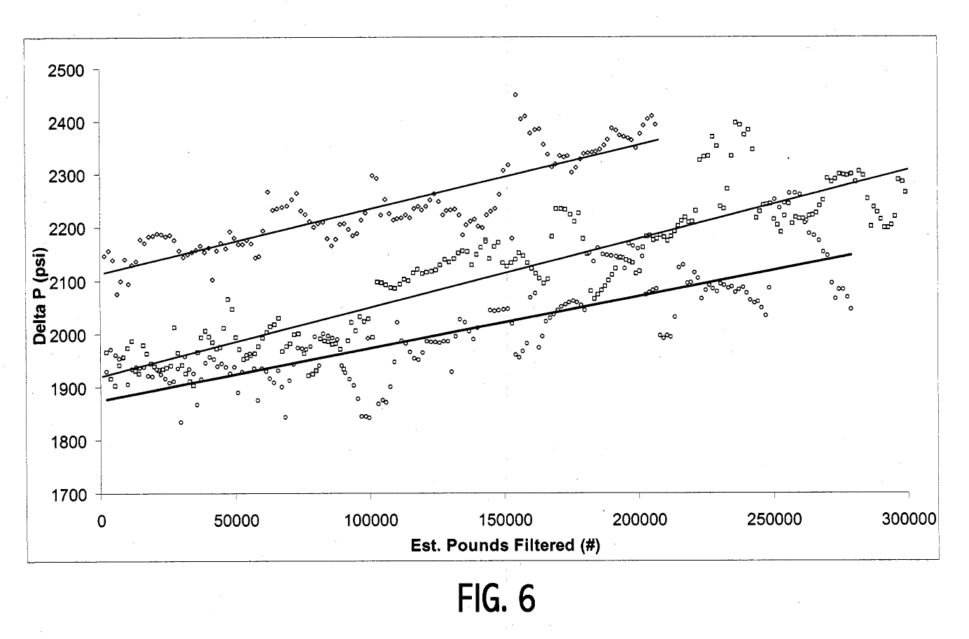

In this example, polyvinyl butyral, or PVB, is filtered using three different candle filter apparatuses. As shown in FIG. 6, results indicate that using either a pleated mesh pack 24 with a conventional hollow tube core 12 (diamonds, top line) or a cylindrical mesh pack and matching conventional hollow core tube (squares, middle line) requires more pressure to begin filtration and, based upon the slope of the regression lines, will reach a maximum pressure value more quickly (i.e., after having filtered less material) than using a hollow core tube 48 and screen pack 47 of the present invention (circles, lower line).

We claim:

1. A filter candle hollow core tube, comprising:
an outer surface and an inner surface and having a longitudinal axis, wherein said outer surface is formed in pleats aligned in parallel with said longitudinal axis, and wherein said hollow core tube defines a plurality of openings between said outer surface and said inner surface and defines an axial opening at one end.

2. The filter candle hollow core tube of claim 1, wherein said plurality of openings are formed within a subregion of said pleats.

3. The filter candle hollow core tube of claim 1, wherein said pleats define grooves aligned in parallel with said longitudinal axis.

4. The filter candle hollow core tube of claim 1, wherein said grooves are formed within a subregion of said pleats.

5. The filter candle hollow core tube of claim 1, comprising at least 15 of said pleats.

6. The filter candle hollow core tube of claim 1, comprising at least 25 of said pleats.

7. The filter candle hollow core tube of claim 1, wherein said pleats project outward from said hollow core tube, as measured in cross section, between 2 mm and 12 mm.

8. A filter candle apparatus comprising:
an elongated screen pack defining an axial opening therethrough;
a hollow core tube slidably, removably disposed within said axial opening of said screen pack, wherein said hollow core tube comprises an outer surface and an inner surface and has a longitudinal axis, wherein said outer surface is formed in pleats aligned in parallel with said longitudinal axis, and wherein said hollow core tube defines a plurality of openings between said outer surface and said inner surface and defines an axial opening at one end; and,
wherein material can be passed through said screen pack, into said hollow core tube, and out of said axial opening defined by said hollow core tube.

9. The filter candle apparatus of claim 8, further comprising gaskets disposed at both ends of said screen pack and said pleats.

10. The filter candle apparatus of claim 9, further comprising a sealing ring disposed in contact with one of said gaskets at said end of said hollow core tube.

11. The filter candle apparatus of claim 9, wherein said screen pack comprises fewer than five separate layers of screen.

12. The filter candle apparatus of claim 9, wherein said screen pack comprises fewer than four separate layers of screen.

13. The filter candle apparatus of claim 9, wherein said screen pack is less than 1.5 mm thick.

14. The filter candle apparatus of claim 8, wherein said plurality of openings are formed within a subregion of said pleats.

15. The filter candle apparatus of claim 8, wherein said pleats define grooves aligned in parallel with said longitudinal axis.

16. The filter candle apparatus of claim 15, wherein said grooves are formed within a subregion of said pleats.

17. The filter candle apparatus of claim 8, comprising at least 25 of said pleats.

18. A method for filtering a flowable material, comprising:
forcing said material through a filter candle apparatus, wherein said apparatus comprises:
an elongated screen pack defining an axial opening therethrough; and,
a hollow core tube slidably, removably disposed within said axial opening of said screen pack, wherein said hollow core tube comprises an outer surface and an inner surface and has a longitudinal axis, wherein said outer surface is formed in pleats aligned in parallel with said longitudinal axis, and wherein said hollow core tube defines a plurality of openings between said outer surface and said inner surface and defines an axial opening at one end.

19. The method of claim 18, wherein said material is a polymer.

20. The method of claim 18, further comprising sealing said screen pack with gaskets.
